(19) United States
(12) Patent Application Publication
(10) Pub. No.: US 2013/0276820 A1
(43) Pub. Date: Oct. 24, 2013

(54) CHEMICAL VAPOR DEPOSITION CHAMBER CLEANING WITH MOLECULAR FLUORINE

(71) Applicants: Jean-Charles Cigal, Bielefeld (DE); Ying-Siang Hwang, TaoYuan (TW); Paul Alan Stockman, Hillsborough, NJ (US); Richard Hogle, Oceanside, CA (US); Stefan Petri, Bielefeld (DE)

(72) Inventors: Jean-Charles Cigal, Bielefeld (DE); Ying-Siang Hwang, TaoYuan (TW); Paul Alan Stockman, Hillsborough, NJ (US); Richard Hogle, Oceanside, CA (US); Stefan Petri, Bielefeld (DE)

(21) Appl. No.: 13/698,800

(22) PCT Filed: Aug. 10, 2011
(86) PCT No.: PCT/US11/47206

§ 371 Date: Jun. 27, 2013

Related U.S. Application Data
(60) Provisional application No. 61/376,775, filed on Aug. 25, 2010.

(51) Int. Cl. B08B 7/00

(52) U.S. Cl. CPC B08B 7/0021
USPC 134/1.1; 134/22.1; 156/345.1

(57) ABSTRACT

Methods and apparatus for the cleaning PECVD chambers that utilize molecular fluorine as the cleaning material.

### FIELD OF THE INVENTION

The present invention relates to new methods for the cleaning chemical vapor deposition (CVD) chambers, particularly plasma-enhanced chemical vapor deposition (PECVD) chambers and to apparatus therefore.

### BACKGROUND OF THE INVENTION

Amorphous and microcrystalline thin films are used to fabricate photovoltaic devices and are generally deposited using chemical vapor deposition techniques. In particular PECVD methods deposit thin films from a gas state to a solid state onto the surface of a substrate by injecting precursor reacting gases into a PECVD chamber and then splitting the gases into active ions or radicals (i.e. dissociated neutral reactive elements) using a plasma created by radio frequency (RF) or DC discharge. The manufacture of devices using PECVD methods includes the depositing of thin films of silicon, silicon oxide, silicon nitride, metals oxides, and others. These deposition processes leave deposits in the chamber that must be periodically cleaned.

There are several known methods for cleaning PECVD chambers. One such method is in-situ activation cleaning wherein the cleaning gas is injected into the chamber and a plasma is ignited. The ions and radicals created by the plasma react with silicon deposits on the sidewalls and showerhead of the chamber. However, in-situ plasma activation can result in plasma induced damage and reduction of equipment and parts lifetime. Further, high pressures need to be avoided because of the risk of arcing.

Another chamber cleaning method is activation of the cleaning gas using a remote plasma source. The cleaning gases first pass through a plasma source situated outside of the chamber where the cleaning gas is dissociated and radicals enter the chamber to perform the cleaning. Higher gas dissociation can be achieved in this manner as compared to in-situ activation and therefore cleaning efficiency can be improved. However, using a remote plasma source requires additional equipment that adds considerable equipment and operations cost. Further, gas flow is often limited by the parameters of the remote plasma source thereby increasing cleaning time and cost.

A further chamber cleaning method comprises thermally cleaning the chamber at high temperatures, typically 600° C. to 900° C. or higher when using gases such as NF₃ or SF₆ that require temperatures of about 900° C. These high temperatures are usually much higher than the temperatures needed for the deposition processes and the required temperature adjustments add to the cleaning time and cost.

Another chamber cleaning method is thermal cleaning at high pressure, e.g. greater than 50 mbar, using molecular fluorine mixed with argon or nitrogen. The high temperatures and high pressures required for this cleaning method are significantly different than the temperature and pressure employed during the deposition processes that therefore again add to cleaning time and cost because of the required temperature and pressure adjustments. Further, this cleaning method may require additional pumping systems therefore adding equipment and operational costs.

All of the above cleaning methods exhibit difficulty reaching shielded areas of the chamber, because the volume of plasma is directly related to the power and ability to sustain an RF field. Therefore, all areas of the chamber can not be reached or cleaned effectively, particularly those areas that are shielded from the RF field.

There remains a need in the art for improvements to apparatus and methods for the cleaning PECVD chambers.

### SUMMARY OF THE PRESENT INVENTION

The present invention provides improved methods and apparatus for the cleaning PECVD chambers that overcome the disadvantages of the prior art methods and apparatus. In particular, the present invention utilizes molecular fluorine for cleaning of the chamber.

### BRIEF DESCRIPTION OF THE DRAWINGS

FIG. 1 is a graph of mass spectroscopy measurements showing the effectiveness of the present invention.

FIG. 2 is a graph showing the expected pressure increase during a chamber cleaning operation using fluorine radicals.

FIG. 3 is a graph showing the pressure increase during a chamber cleaning operation using molecular fluorine according to the present invention.

FIG. 4 is a graph showing pressure changes during a chamber cleaning operation according to the present invention.

FIG. 5 is a close up graph showing pressure changes during a chamber cleaning operation according to the present invention.

### DETAILED DESCRIPTION OF THE INVENTION

The present invention uses molecular fluorine for PECVD chamber cleaning. These PECVD chambers are used to deposit silicon (both amorphous and microcrystalline) for photovoltaic devices. Generally, the deposition processes are carried out at temperatures as low as 160° C. and do not need plasma activation, either in-situ or remote.

For cleaning of the PECVD chamber according to the present invention, fluorine is introduced to the chamber at a predetermined pressure. Cleaning of the chamber is accomplished solely by the reaction of molecular fluorine with deposited silicon on the interior walls and equipment of the PECVD chamber. The time needed for cleaning is dependent on the predetermined pressure and surface temperature.

In accordance with the present invention, it has been found that it is possible to clean the PECVD chamber at base pressure obtained by having the valves from the chamber to the pump foreline fully open. Pressures as low as 350 mTorr (0.47 mbar) were obtained. Further experiments show that cleaning process pressures between 5 Torr and 9 Torr provide efficient and thorough cleaning of the chamber in times suitable for industrial application and competitive with the currently available cleaning techniques.

The cleaning of chambers using molecular fluorine according to the present invention can be further enhanced by combination with other methodologies. For example, the molecular fluorine may be at least partially ignited with a plasma, either in-situ or using a remote plasma source. In addition, both dynamic and static treatment of the chamber can be carried out. When performing a dynamic clean, the pressure is maintained in the chamber and the cleaning gas (molecular fluorine) is continuously fed into the chamber and continuously evacuated from the chamber. In this fashion, molecular fluorine gas is continuously regenerated in the chamber and SiFx that is formed by the cleaning is evacuated. In a static clean treatment, the chamber is filled with the cleaning gas up to a certain pressure but is not evacuated. After a predetermined time period, the chamber valve is opened and the cleaning product gas is evacuated. The principle of static clean is to fill the chamber, wait for the cleaning gas to react completely and then evacuate the product gases. In static clean operations, gas utilization is at a maximum, but enough cleaning gas must be used to clean all of the silicon deposits. A combination of dynamic and static clean processes may provide superior results and be most advantageous.

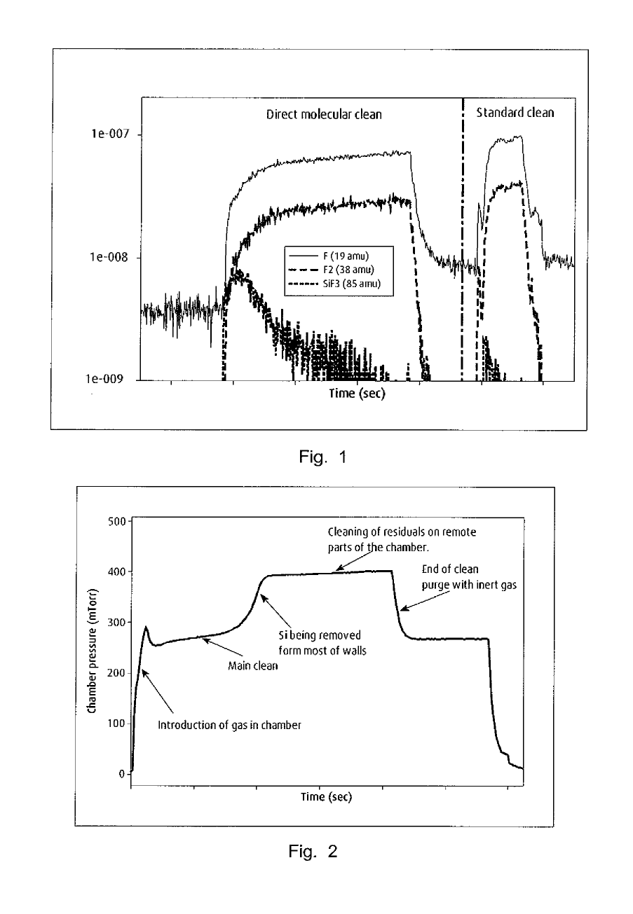

The ability to clean PECVD chambers according to the present invention was confirmed by mass spectrometry measurements as shown in FIG. 1. In particular, chamber cleaning was carried out using direct molecular fluorine as the cleaning agent according to the present invention, followed by a standard cleaning procedure using a state of the art remote plasma source to activate the cleaning agent. The mass spectrometry results of FIG. 1 show that very low levels of silicon remained after the direct molecular fluorine clean of the present invention, thereby proving the efficiency of the cleaning method of the present invention.

As noted above, it is known that silicon films can be removed from the reactor chamber by using dissociated fluorinated molecules that can be obtained by dissociation of a fluorine containing gas using either an in situ generator (e.g. an RF or microwave generator in the chamber) or by using a remote plasma source. The fluorine radicals or ions react with the silicon to form SiF₄ according to the general reaction:

2F₂(g)+Si(s)→SiF₄(g).

During normal cleaning operations the pressure of the chamber is not fixed but experiences pressure changes during the cleaning procedure. In particular, during the main clean all of the fluorine radicals react with silicon creating a stationary regime or near equilibrium with only a slight pressure increase. However, when silicon has been removed from some areas of the chamber, not all of the fluorine radicals can react with silicon and the pressure of the chamber experiences an abrupt increase. This abrupt increase is followed by stabilization at the point where almost all of the silicon has reacted. This sequence of pressure changes is shown in FIG. 2.

The cleaning process of the present invention using molecular fluorine is normally carried out at a fixed pressure set to optimize the cleaning rate. It has been found that the higher the chamber pressure is set, the faster the chamber is cleaned. It was expected that a similar chamber pressure sequence would occur in the cleaning process of the present invention as that shown in FIG. 2 for fluorine radical cleaning. In particular, with the desire to keep the chamber as a fixed pressure, it was determined that a compensation means would need to be employed to offset the increased pressure that occurs as the silicon is consumed. Therefore, the present invention was run with a pressure regulation system, e.g. modification of the aperture of the valve connecting the chamber to the pumping line. However, during experiments run according to the present invention, no movement of the pressure regulation system was observed.

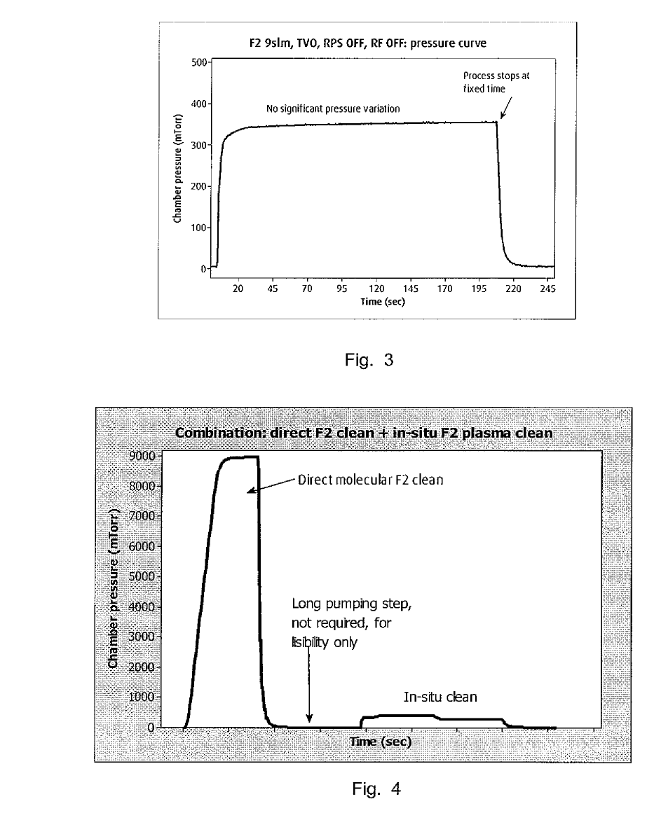

The cleaning process of the present invention using molecular fluorine was also tested running at base pressure, i.e. without setting a fixed chamber pressure. For these experiments the cleaning time was extended. No significant pressure increase within the chamber was observed in these test runs either. This pressure curve for this process is shown in FIG. 3. Cleaning of the chamber was confirmed by mass spectrometry measurements and verified that no residual silicon film was present following the extended cleaning time.

These results lead to a new interpretation of the mechanism of the cleaning process using molecular fluorine. In particular, it is now believed that the silicon reacts with the molecular fluorine (F₂) to form SiF₂ (g) and is evacuated from the chamber before combination and formation of SiF₄ can occur.

In some cases, for instance depending on the materials used to make the chamber of parts thereof, some residual silicon (i.e. very thin layers of silicon) may remain on the chamber surfaces even after the cleaning process has been carried out. This can be generally attributed to chamber material porosity, or specific strong bonding between the silicon atoms and the atoms of the chamber material surface. In order to remove this residual silicon, the present invention adopts a combination of direct molecular fluorine cleaning as described above with a short fluorine plasma treatment. In particular, once the initial direct fluorine cleaning is completed, then a plasma can be ignited in the chamber to generate energetic fluorine ions or radicals that can remove the thin residual silicon films in a very short treatment time.

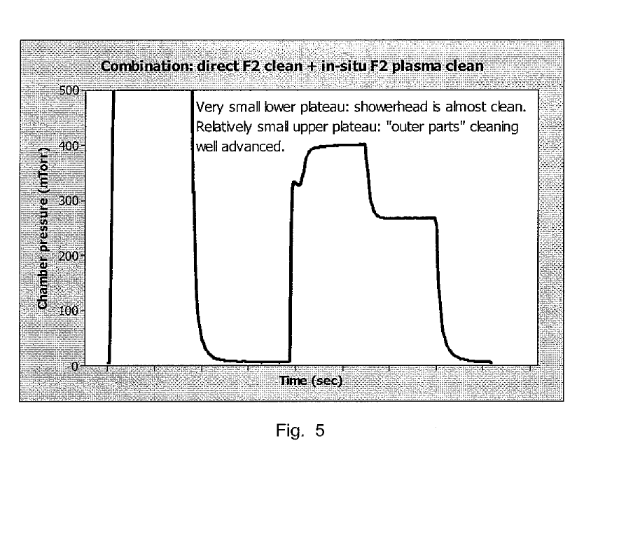

This combination of cleaning stages is shown in FIGS. 4 and 5. First a direct molecular cleaning is carried out at a fixed chamber pressure for a set period of time. The F₂ supply is then stopped and the chamber is pumped down to al low value, e.g. several hundred millitorr. The chamber is then filled again with F₂ and a plasma is ignited in the chamber. The cleaning process is ended when the pressure stabilizes itself. As can be seen in FIGS. 4 and 5, because there is no lower plateau during the plasma clean, e.g. there is no evidence of silicon being consumed, it is indicated that the chamber was essentially clean after the direct molecular cleaning stage.

The use of molecular fluorine for PECVD chamber cleaning provides several advantages over the chamber cleaning operations know in the prior art. In particular, as compared with plasma activation of cleaning gases (both in-situ and remote); the present invention does not require plasma activation. Therefore, the present invention eliminates problems associated with gas flow and chamber pressure that are necessitated when using plasma activation. Further, the present invention eliminates the risk of plasma induced damage to the chamber and equipment. Moreover, the present invention provides better cleaning of all areas of the chamber. This is because plasma at high pressure as used in the prior art tends to shrink thereby leading to poor cleaning of remote portions of the chamber. Further, because no plasma activation is needed in the present invention, there is no need for a remote plasma source, therefore eliminating the extra cost and space required in the prior art systems.

In the cleaning operation of the present invention wherein molecular fluorine cleaning is followed by a short plasma cleaning, there are still several advantages. In particular, the plasma cleaning stage can be quite short and therefore avoids significant risk of plasma induced damage to the chamber and equipment. The plasma treatment portion of the cleaning process can be carried out in situ, meaning there is no need for a remote plasma source, therefore reducing cost and space requirements.

The present invention is also more advantageous than known high temperature thermal clean operations. In particular, since the present invention can be carried out at temperatures as low as 180° C., the PECVD chamber can be cleaned at the same temperature as is used for the deposition process. Because there is no need to adjust temperature of the chamber between deposition and cleaning processes, the present invention can be carried out in less time, thereby reducing operational cost.

With respect to thermal cleaning at high pressure, the present invention again offers advantages. In particular, the present invention provides efficient cleaning at low pressures and therefore can be carried out at pressures normally used during the deposition process. By eliminating the need for high temperatures and high pressures cleaning time is reduced and operational costs are lowered. Further, not additional pumping systems are required.

The present invention provides efficient cleaning to all areas of the PECVD chamber. Because no plasma activation is necessary, no RF source is needed. Therefore, there are no portions of the PECVD chamber that are shielded because of the RF field or equipment. This results in more thorough and uniform cleaning of the PECVD chamber when using molecular fluorine according to the present invention.

The above discussion of the present invention focuses on the use of molecular fluorine for PECVD chamber cleaning. However, the present invention may also be useful for selective etching of silicon. In particular, molecular fluorine is inefficient at reacting with either silicon oxide or silicon nitride. Therefore, it is possible to selectively etch silicon even when silicon oxide or silicon nitride is present. Further, the present invention may be useful for the cleaning of silicon coated materials.

It is anticipated that other embodiments and variations of the present invention will become readily apparent to the skilled artisan in the light of the foregoing description, and it is intended that such embodiments and variations likewise be included within the scope of the invention as set out in the appended claims.

What is claimed:

1. A method of cleaning a chemical vapor deposition chamber comprising:
introducing molecular fluorine into the chamber;
allowing the molecular fluorine to react with unwanted deposits in the chamber; and
evacuating the chamber.

2. A method according to claim 1 wherein the chamber is a plasma enhanced chemical vapor deposition chamber.

3. A method according to claim 1 wherein the chamber is maintained at a fixed pressure during the cleaning process.

4. A method according to claim 3 wherein the fixed pressure is between 5 Torr and 9 Torr.

5. A method of cleaning a chemical vapor deposition chamber comprising:
introducing molecular fluorine into the chamber;
allowing the molecular fluorine to react with unwanted deposits in the chamber;
evacuating the chamber;
introducing fluorine into the chamber;
igniting a plasma in the chamber to create fluorine radicals;
allowing the fluorine radicals to react with any residual unwanted deposits in the chamber; and
evacuating the chamber.

6. A method according to claim 5 wherein the chamber is a plasma enhanced chemical vapor deposition chamber.

7. An apparatus for cleaning a chemical vapor deposition chamber comprising:
a deposition chamber; and
a source of molecular fluorine connected to the deposition chamber.

8. The apparatus of claim 7 wherein the chamber is a plasma enhanced chemical vapor deposition chamber.

9. The apparatus of claim 7 further comprising means to maintain a fixed pressure in the chamber.
